(19) United States
(12) Patent Application Publication
(10) Pub. No.: US 2011/0043360 A1
(43) Pub. Date: Feb. 24, 2011

(54) PORTABLE COLLAPSIBLE IR DETECTION SYSTEM

(75) Inventors: Joseph Noah Mintz, Carlsbad, CA (US); Jeffrey Lewis Amram Summit, Jefferson, MA (US)

Correspondence Address: Joshua S. Schoonover;Coastal Patent, LLC, PO Box 232340, San Diego, CA, 92193, US

(73) Assignee: NOVATAC, INC., Carlsbad, CA (US)

(21) Appl. No.: 12/859,748

(22) Filed: Aug. 19, 2010

Related U.S. Application Data
(60) Provisional application No. 61/235,183, filed on Aug. 19, 2009.

(51) Int. Cl. G08B 21/00; G01J 5/02

(52) U.S. Cl. 340/540; 250/347

(57) ABSTRACT

A portable infrared (IR) detection system can be used to scan an adjacent terrain and detect an IR source, such as a person or animal, by detecting heat emitted therefrom. Humans, animals and other sources emit IR radiation which can be detected by an IR detector. The emitted radiation is captured by a tube and reflected onto a sensor using a parabolic or other reflector. The sensor is connected to a display component for producing an audible, visual, or vibrational alert. Activities such as hunting, boating, and camping, often accompany situations where detection of a human, animal, or other heat source can be a valuable tool. This invention provides a portable IR detection system for use in these and other activities, the portable detection system being collapsible, portable and cost-efficient.

### CROSS REFERENCE TO RELATED APPLICATIONS

This application claims priority to U.S. Provisional Patent Application Ser. No. 61/235,183 filed Aug. 19, 2009, and titled “COLLAPSIBLE IR DETECTION SYSTEM”; the entire contents of which are hereby incorporated by reference.

### FIELD OF THE INVENTION

The present invention relates to a portable detection apparatus for detecting a heat source. More particularly, the invention relates to a portable, collapsible infrared detection system for use in a variety of sports and activities such as hunting, boating, camping, and the like.

### BACKGROUND OF THE INVENTION

Recreational outdoor activities such as hunting, boating, camping, hiking, and others, often accompany situations where detection of a human, animal, or other heat source can be a valuable asset. For example, boating at night or in dense fog can be a dangerous activity, especially considering the possibility of a person falling from the boat. In such a situation, immediate action to locate and recover the fallen person can be necessary to prevent harm, or death. In other examples, recreational hunters and other outdoorsman can benefit from a detection system capable of detecting other humans, animals, and other heat sources. Currently available IR detectors are overwhelmingly large and heavy, making them intolerably non-portable, as well as expensive and impractical for recreational use.

Infrared sensors are known in the art and include the Pyroelectric infrared (PIR) sensor. Pyroelectric sensors are typically used in passive infrared detection systems, such as home security system “motion sensors” or “Passive Infrared Detectors”. The PIR sensor differentiates between two IR sources, i.e. the IR emitted from a wall and the IR emitted from a human passing in front of the wall, hence the “motion sensor”. As the increase in IR is detected by the PIR, a relay is switched, thereby creating a signal to the alarm or other security device. The PIR sensor is an abundantly available off-the-shelf item, available at an affordable price, and useful in detecting an IR source. PIR sensors, as currently used in Passive Infrared Detectors, are not portable and often fixed mounted to a wall or other object. Additionally, PIR sensors, as currently used in Passive Infrared Detectors, have a limited range of operability, usually less than 6 meters (20 feet).

PIR sensors are described in U.S. Pat. Nos. 7,399,969; 7,399,970; 7,042,134; 7,141,910; 7,352,107; and 7,498,576, by Micko and assigned to “Suren Systems, Ltd”; the entire contents of which are hereby incorporated by reference.

Currently available products for detection of humans, animals, and other heat sources include fixed-mounted Passive Infrared Detectors, Signal emitters and receivers, dye markers, and others. Most of these products are directed towards safety/rescue equipment, however, a few products exist for detecting game, and campsite intruders.

One example of the current state of the art concerning recreational IR detection systems as applied to man-overboard situations is disclosed in U.S. Pat. No. 7,335,077 by Chiappetta entitled “MAN OVERBOARD DETECTION AND RESCUE SYSTEM”, the entire contents of which are hereby incorporated by reference. Chiappetta discloses the use of several fixed mounted Passive IR Detectors surrounding the hull of a boat. When a person falls off the boat, one or more Passive IR Detectors recognize the fallen person and sound an alarm. The embodiments described in Chiappetta suffer a number of problems. For example, the large number of Passive IR Detectors are fixed-mounted around the hull of the vessel, thereby requiring a substantial investment for the number of detectors, and inherently providing a number of corrodible components, especially for boats used and or kept in saltwater.

Additionally, the Passive Infrared Detectors have a limited range of about 6 meters, or 20 feet, thus although the detectors may recognize a person falling over, these detectors are incapable of locating the fallen comrade outside of the 20 foot zone, thereby being incapable of assisting in the rescue at night or in the fog.

Another example of the current state of the art concerning recreational IR detection systems as applied to boating is disclosed in U.S. Pat. No. 7,105,800 by Staerzi entitled “DETECTION SYSTEM AND METHOD FOR A PROPELLER DRIVEN MARINE VESSEL WITH A FALSE TRIGGERING PREVENTION CAPAILITY”, the entire contents of which are hereby incorporated by reference. Staerzi discloses a pair of fixed-mounted IR detectors located near the aft of the vessel, these detectors are configured to shut off the propeller in a man overboard situation. One problem with this embodiment is the limited range of operation of these sensors, and although the sensors detect a man overboard, they are hardly useful in locating a fallen person beyond 20 feet, or within 20 feet and in the night or in fog.

There is a need for an affordable, portable, light-weight IR detector capable of operation beyond the currently available range of 20 feet. The detector being useful for locating a man overboard for rescue, detecting nearby game for hunting, and removably mountable to a fixed surface, boat, tripod or other structure.

### SUMMARY OF THE INVENTION

This invention solves the aforementioned problems and provides an affordable, lightweight IR detector capable of operation at large distances. The IR detector includes a collapsible tube for receiving IR signals, a Pyroelectric Infrared (PIR) Sensor, and a display component for presenting the detected signal.

The collapsible tube can be configured as a series of slideably engaged rings or telescoping rings, an accordion tube, a first and second annular component connected by a length of material, or any other collapsible tube design which incorporates a first and second annular member having a length of material in-between. The collapsible tube provides a portable device capable of long range IR detection, as a larger tube will yield a longer range of operability.

The Pyroelectric Infrared (PIR) Sensor is an abundantly available IR sensor providing cost-effective IR detection, broadband range, and minimal power consumption. The PIR sensor is small, light weight, and reliable. Any IR sensor available in the art will work, however the PIR Sensor is preferred for its size, weight, and broadband range.

The display component for presenting the detected signal can be an LCD display, a display-graph or bar-display, an alarm or bell, an LED, light bulb, electric vibrational motor, or any other visual, audio, or vibrational component known in the art.

In one embodiment of the invention, the portable IR detector includes an expandable tube for collecting an IR source having a proximal and a distal end. The portable IR detector has a handle attached to the expandable tube at the proximal end, and a PIR sensor configured in the center of the expandable tube at the distal end, the PIR sensor configured to face the proximal end of the expandable tube. A parabolic reflector for directing the IR to the PIR sensor is attached to the expandable tube at the proximal end, such that IR collected by the expandable tube is reflected toward the focal point, i.e. the location of the PIR sensor.

In another embodiment, the detector includes an expandable tube having a proximal and a distal end, with a handle located at the proximal end. A PIR sensor is located at a proximal end and faces the distal end of the expandable tube.

In another embodiment, the detector includes an audio component. Upon detecting a change in IR source, the sensor triggers an electrical relay, which in turn enables a circuit having an audio component such as a speaker, buzzer, or other audio signal, and an audio notification is produced for the user.

In another embodiment, the detector includes an LCD for displaying the differential in temperature detected by the PIR sensor.

In another embodiment, the detector includes one or more LEDs for displaying the differential in temperature detected by the PIR sensor.

In another embodiment, the detector includes a bar-graphical display for displaying the differential in temperature detected.

In another embodiment, the detector includes a phono jack for the use of headphones in conjunction with a separate display device. For example, the detector can include a bar-graphical display for visual depiction of the differential in temperature detected by the PIR sensor, and a headphone jack for the use of headphones which provide a user with an additional audio display of the relative IR detected source.

In one embodiment, the signal is an audio signal, which is volume-sensitive, i.e. is stronger (louder) upon detecting a stronger differential in temperature detected. The volume is configurable to a user's preference.

### BRIEF DESCRIPTION OF THE DRAWINGS

These and other attributes of the invention are further described in the following detailed description, particularly when reviewed in conjunction with the drawings, wherein:

FIG. 1 is a perspective view of the Portable IR detector in an expanded state.

FIG. 2 is a perspective view of the Portable IR detector in a collapsed state.

FIG. 3 is a planar view of the detector at a distal end, wherein a PIR sensor is configured at the focus of the expandable tube.

FIG. 4 is a planar view of an expandable tube, the expandable tube in the configuration of an accordion-tube in a semi-compressed state.

FIG. 5 is a planar view of the expandable tube of FIG. 4, the expandable tube configured in a fully expanded state.

FIG. 6 is a planar view of an expandable tube, the expandable tube in the configuration of a telescoping cylinder.

FIG. 7 is a planar view of the expandable tube of FIG. 6, the expandable tube in a fully compressed state.

FIG. 8 is a perspective view of the portable IR detector, the detector having an expanded tube and a PIR sensor at a distal end, and a handle containing a power source at a proximal end of the tube.

FIG. 9 is a representative illustration of various angles and distances associated with the operability of the present invention.

FIG. 10 is a table illustrating the calculated operability of the invention in a representative embodiment.

### DETAILED DESCRIPTION OF THE PREFERRED EMBODIMENTS

The following written description, in conjunction with the drawings and claims, sets forth details and examples of one or more preferred embodiments sufficient to enable one having ordinary skill in the art to make and use the invention. The following examples are provided as non-limiting illustrations of some of the features included in one or more preferred embodiments. The following examples are for illustrative purposes only, and should not be construed as limiting the spirit and scope of the invention.

A portable IR detector is provided having an expandable collection tube, a Pyroelectric Infrared (PIR) Sensor, and a display component for providing at least one of an audio, visual, or vibrational alert upon the reading of an IR source.

The expandable collection tube is intended to include any tubular member which can be expanded from a collapsed state to an expanded state. Examples of expandable tubes include the accordion tube and the telescoping tube, however any collapsible tube can be used. The accordion tube is generally a tube which folds on itself. The telescoping tube is generally a tube which is slideably collapsed into a reduced size. Other collapsible tubes can include two or more annular members connected by a length of material or fabric, or a flexible tube which is configured to roll onto itself.

Pyroelectric infrared (PIR) sensors are used in security alarm system components such as “motion sensors”. These “motion sensors” are actually temperature detectors which read the infrared emitted in a targeted region. As a source emitting infrared energy enters the field of view of the PIR sensor, the sensor sends a signal to a relay which in turn opens a circuit for an alarm or other electrical component.

By design, a PIR sensor is unidirectional. A Passive Infrared Detector (PID) is an assembly which includes a PIR sensor and an optical component for directing infrared radiation to the PIR sensor. Currently available PIDs include a PIR sensor, and a Fresnel lens for directing the IR to the PIR sensor. For purposes of this invention, it has been determined through experimentation that a tube for collection of infrared radiation enhances detection at distances beyond 6 meters.

In one embodiment, the invention includes a tube having a proximal end and a distal end, and a PIR sensor fixed at the distal end. The PIR sensor is configured to face the proximal end of the tube, where a reflector is used to direct the infrared radiation towards the PIR sensor. The invention further includes a display component for communicating the level of infrared detected to a user. The display component can be at least one of a visual, audio, or vibrational display component.

The PIR sensor can be fixed to a circuit board, along with other electronic components for optimization of the sensor. Additionally, a relay such as a normally closed (NC) relay can be used in combination with the display component to provided real-time display of infrared levels. Any relay or similar component will yield similar results.

In another embodiment, the invention includes an expandable tube having a proximal end and a distal end, and a PIR sensor fixed at the distal end. The PIR sensor is configured to face the proximal end of the tube, where a reflector is used to direct the infrared radiation towards the PIR sensor. The invention further includes a display component for communicating the level of infrared detected to a user. The display component can be at least one of a visual, audio, or vibrational display component. The expandable tube provides a collapsible reduction in size for easy storage and portability.

The display component can be any component designed to convert an electrical signal into a visual, audio, or vibrational display. Examples include light emitting diodes (LEDs), liquid crystal display (LCD), analog display, bar graphical display, buzzer, speaker, and a vibrating motor. Any display component can be used. When the sensor detects a differential in temperature detected, a relay is triggered which enables the display component to communicate the level of infrared detected.

In one embodiment, the invention comprises a tube having a proximal end and a distal end, a PIR sensor, and a plurality of LEDs. The PIR sensor is configured with an electrical circuit to enable the LEDs to light up when infrared radiation is detected. The plurality of LEDs are configured in a linear fashion, and the number of LEDs for illumination varies with respect to the amount of infrared radiation detected, thus a higher signal will correspond to a larger number of LEDs illuminated. The tube can be fixed or collapsible, depending on the requirements for portability.

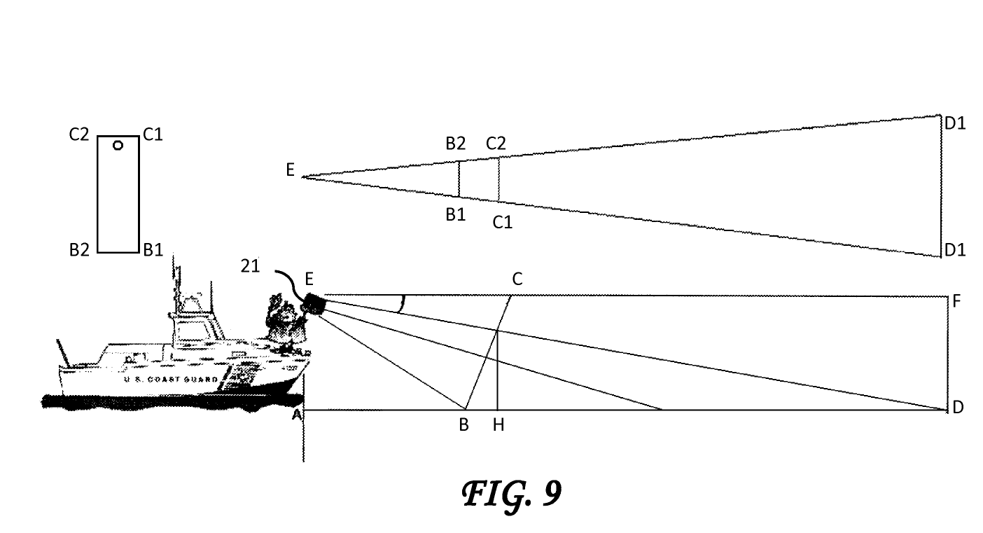

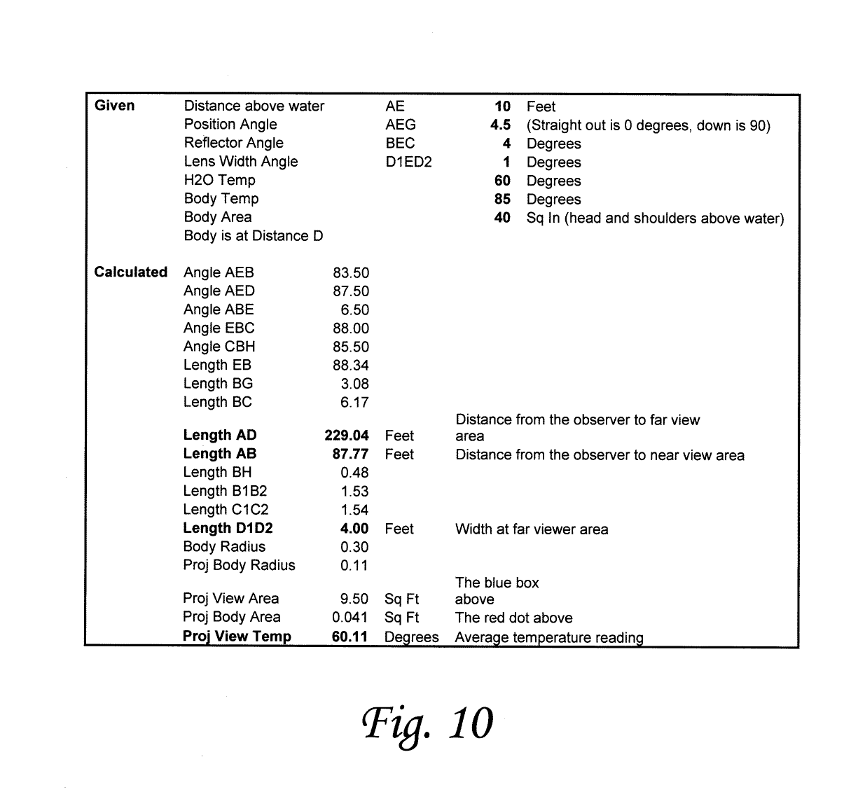

The distance at which the Portable IR Detector is operable will depend on the diameter and length of the tube, the reflector angle, and other factors. FIG. 9 illustrates the angles and distances for determining the operability of the Portable IR Detector. As illustrated by FIG. 9, the Portable detector at a position of 10 feet above the water line, having a position angle of 4.5 degrees below horizontal, a reflector angle of 4 degrees, and a lens width angle of 1 degree, has a range of operability at approximately 229 feet. One having ordinary skill in the art can use the geometry illustrated in FIG. 9 to determine the range of operability for a Portable Infrared Detection System having variable tube and reflector properties. FIG. 10 is used in conjunction with FIG. 9 to illustrate the range of operability in one embodiment of the invention.

A processor can be used to process data relative to a given position of the Portable IR Detector, such that the detector can scan a field of view so as to record the thermographic data relative to each unique position or frame, the result would be a thermographic display of a scanned area. A user can use the Portable IR Detector to scan or sweep a targeted area for changes in temperature with respect to position. Additionally, as the unit is repositioned over a previously scanned frame, a current read providing updated thermographic data can be updated with the display, such that an oscillating sweeping motion of the detector can provide real-time display of relative thermographic data.

In another embodiment, the Portable IR detector can include a tube having a proximal end and a distal end, a PIR sensor fixed in the center of the tube at the distal end, and a reflector at the proximal end. The reflector can be a parabolic reflector, a Fresnel reflector, or similar reflector. The detector further includes a handle attached to the tube, for handheld scanning. The detector includes a relay and a processor for processing realtime thermographic data to an LCD.

The LCD is configured with an area of pixels, each pixel corresponding to a frame. As the detector reads the temperature at a point of reference (frame), the processor records the position, angle and thermographic data, collectively referred to as the map, and transmits the map data to the LCD screen for visual display. As the detector scans several frames, the LCD displays corresponding maps, thereby allowing a user to visualize the relative thermographic intensity with reference to the area scanned.

The detector can further include a buzzer or speaker for audio display of thermographic intensity. Using a transducer and an amplifier, the speaker or buzzer can variably provided an audible signal in correlation with the thermographic intensity scanned. Such an audible signal will enable a user to quickly scan and pinpoint the location of a thermo-source, such as a man overboard.

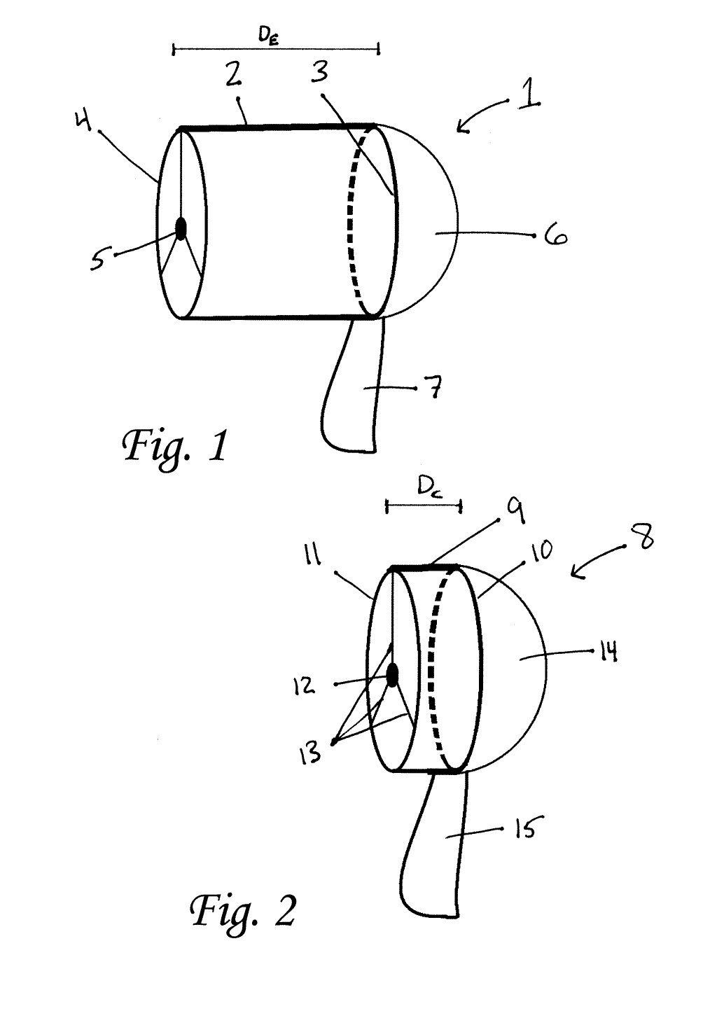

FIG. 1 illustrates an embodiment of the invention, the Portable Infrared Detector 1 includes a tube 2 having a proximal end 3 and a distal end 4 and an expanded length (DE). The detector further includes a PIR sensor 5 fixed in the center of the tube at the distal end 4, and a reflector 6 at the proximal end 3. A handle 7 is attached to the tube 2 at the proximal end 3.

FIG. 2 illustrates a collapsed detector 8, having a collapsible tube 9 in the collapsed state with a length of (DC). The expandable/collapsible tube 9 has a proximal end 10 and a distal end 11. A PIR sensor 12 is fixed at the distal end 11 of the tube 9 by three positioning members 13. A reflector 14 is attached to the tube at the proximal end 10 along with a handle 15 for holding the portable detection system 8.

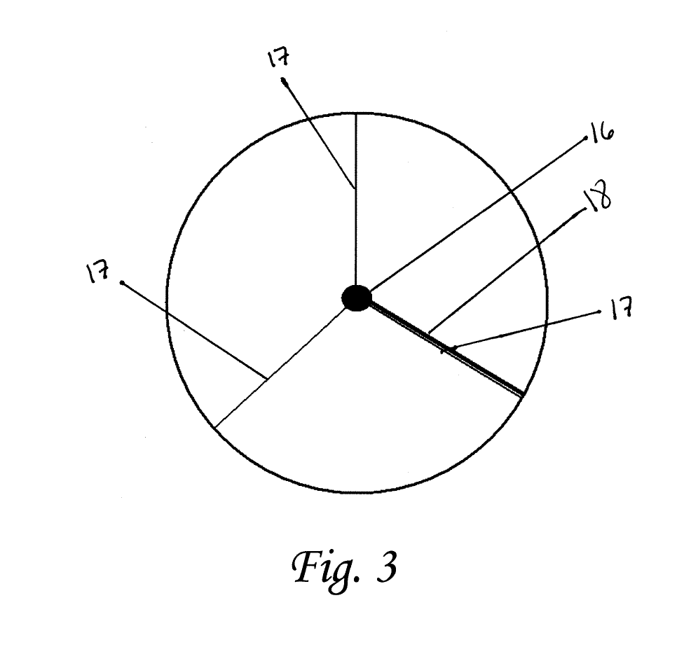

FIG. 3 illustrates the front view of the detector at the distal end of the tube. A PIR sensor 16 is fixed in the center of the tube using three positioning members 17. One or more wires 18 attached to the PIR Sensor are affixed adjacent to one of the positioning members and connected to a circuit board.

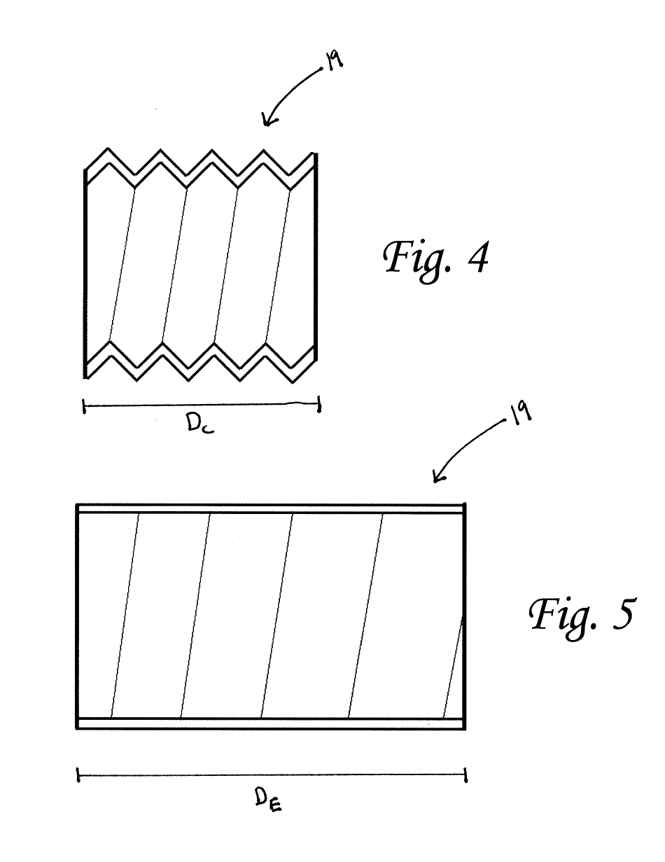

FIGS. 4-5 illustrate a collapsible tube in the configuration of an accordion tube 19. The accordion tube 19 being capable of folding on itself, and has an expanded distance (DE) and a collapsed distance (DC).

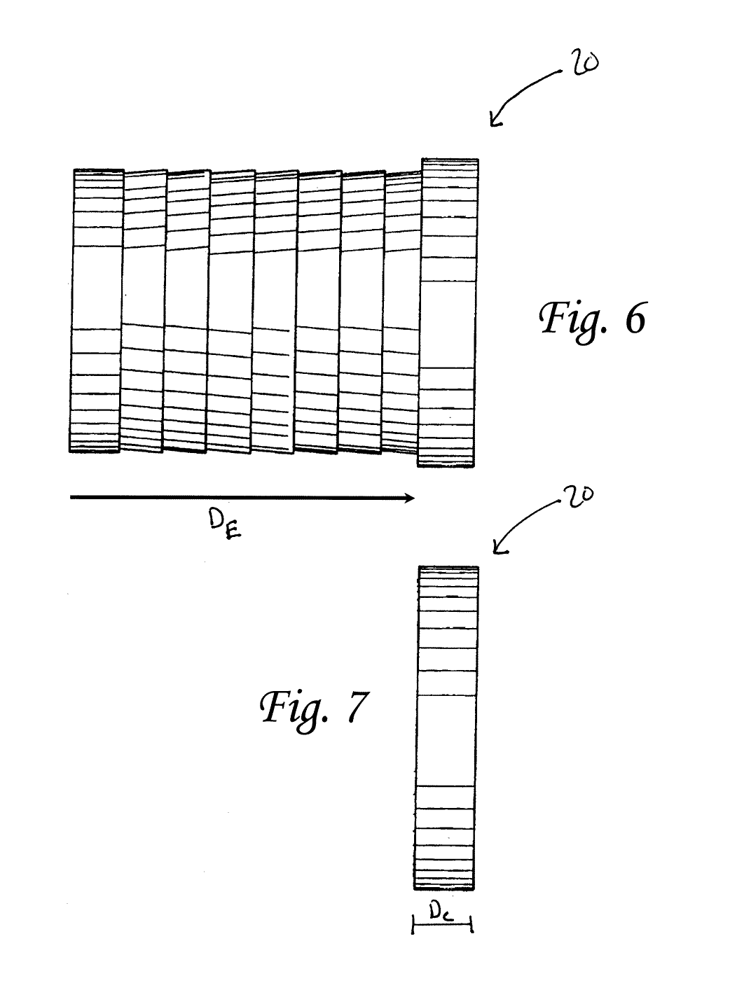

FIGS. 6-7 illustrate a collapsible tube in the configuration of a telescoping tube 20. The telescoping tube 20 being capable of slideable engagement, and collapsing into itself. The telescoping tube has an expanded distance (DE) and a collapsed distance (DC).

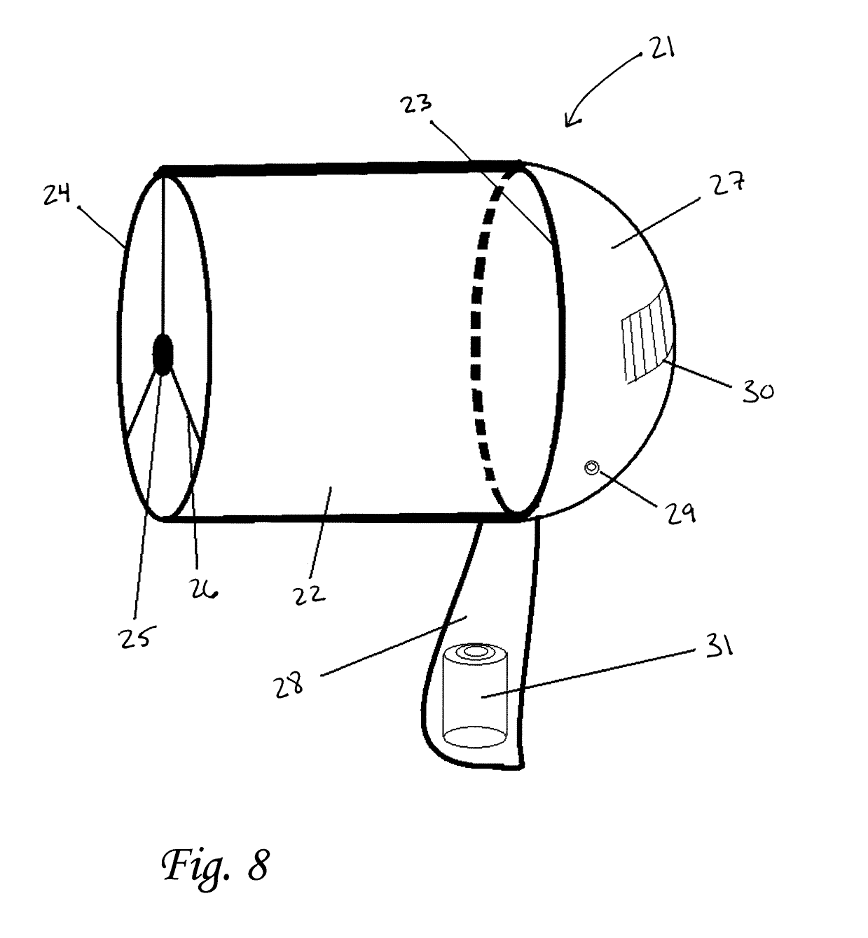

FIG. 8 illustrates a Portable Infrared Detection System 21, the detector including a tube 22 having a proximal end 23 and a distal end 24, a PIR sensor 25 attached at the distal end 24 of the tube 22 by a number of positioning members 26, and a reflector 27 attached to the proximal end 23 of the tube 22. The detector further includes a handle 28 attached to the tube. The detector includes a phono jack 29 for the use of a speaker accessory or headphones. The detector also includes a bar graphical display 30. One or more batteries 31 can be stored in the handle 28 of the detector for improved portability.

FIGS. 9-10 illustrate angle and distance calculations for the operability of the present inventive collapsible IR detector. Although the illustration in FIG. 9 refers to a collapsible IR detector for use on a boat, it will be understood by those skilled in the art that the collapsible detector will work in other applications, such as hunting, hiking, camping, and others. FIG. 9 provides a reference for various distances and angles relating to the operability of the Collapsible IR Detector. FIG. 10 is a table illustrating the calculated values of the referenced distances and angles of FIG. 9 in one given embodiment where the distance above water is 10 feet, position angle is 4.5 degrees, reflector angle is 4 degrees, lens width angle is 1 degree, water temperature is 60 degrees Fahrenheit, body temperature is 85 degrees Fahrenheit, and body area including head and shoulders above the water is 40 square inches. It will be understood by those having skill in the art that these parameters vary with respect to operability and that calculated values will vary from these representations, however, the illustrated embodiment of FIGS. 9-10 provides an average circumstance where operability is calculated to a distance of 229 feet, a significant improvement of any currently available IR detector.

The aforementioned detailed description describes a number of features of the present invention. It will be understood by one having ordinary skill in the art that other combinations can be used without deterring from the spirit and scope of the invention.

We claim:

1. A portable IR detection system, comprising:
an expandable tube having a proximal end and a distal end, and
a Pyroelectric Sensor fixed at the center of the tube at said distal end.

2. The portable IR detection system of claim 1, further comprising a reflector.

3. The portable IR detection system of claim 2, wherein the reflector is one of a parabolic reflector or a frennel reflector.

4. The portable IR detection system of claim 2, further comprising a handle.

5. The portable IR detection system of claim 3, wherein said handle is located at the proximal end of the expandable tube.

6. The portable IR detection system of claim 1, further comprising a display component.

7. The portable IR detection system of claim 5, wherein said display component is one of an Audio, Visual, or Vibrational display component.

8. The portable IR detection system of claim 6, wherein said display component is selected from the group consisting of: LED, LCD, Bar Graphical Display, Speaker, vibrational motor, and a light bulb.

9. The portable IR detection system of claim 7, further comprising a phono-jack for connecting headphones.

10. The portable IR detection system of claim 1, wherein the expandable tube is an accordion tube.

11. The portable IR detection system of claim 1, wherein the expandable tube is a telescoping tube.
